(19) United States
(12) Patent Application Publication
(10) Pub. No.: US 2019/0091903 A1
(43) Pub. Date: Mar. 28, 2019

(54) PRESS AND METHOD FOR MOLDING EXPANDED THERMOPLASTIC POLYMERS

(71) Applicant: ALESSIOHITECH S.R.L., Bergamo (IT)

(72) Inventor: Gianni Franco ALESSIO, Presezzo (IT)

(73) Assignee: ALESSIOHITECH S.R.L., Bergamo (IT)

(21) Appl. No.: 16/083,599

(22) PCT Filed: Mar. 9, 2017
(86) PCT No.: PCT/EP2017/055596

§ 371 Date: Sep. 10, 2018

(30) Foreign Application Priority Data
Mar. 11, 2016 (IT) 102016000025592

(51) Int. Cl. B29C 44/44; B29C 44/58; A42C 2/00

(52) U.S. Cl. CPC B29C 44/445; B29K 2101/12; A42C 2/002; B29C 44/58

(57) ABSTRACT

A press for molding expanded thermoplastic polymers, comprising at least one portion comprising a fixed plane with a first chamber and a movable plane with a chamber, the fixed plane and the movable plane comprising at least one male mold part and at least one female mold part, which form at least one cavity upon closure; the fixed plane of the at least one portion comprises, in a second chamber obtained inside the first chamber, a duct for dispensing steam inside the second chamber, adapted to superheat the at least one male mold part and/or the at least one female mold part, and a duct for dispensing water inside the second chamber, adapted to cool the at least one male mold part and/or the at least one female mold part, and a condensation discharge duct.

The present invention relates to a press and a method for molding expanded thermoplastic polymers, particularly but not exclusively useful and practical in the field of the production, by means of an injection molding process, of manufactured articles and components provided by using as raw materials expanded thermoplastic polymers, such as can be for example EPP (Expanded Polypropylene), EPS (Expanded Polystyrene), EPE (Expanded Polyethylene), ETPU (Expanded Thermoplastic Polyurethane), and ETPO (Expanded Thermoplastic Polyolefin).

In general, materials that belong to the group of expanded thermoplastic polymers have various valuable characteristics, which can include for example mechanical strength, light weight, elasticity and impact memory.

By virtue of these characteristics, expanded thermoplastic polymers are adopted in many fields of industry, such as for example the automotive sector or the transportation sector in general, where they constitute the main materials used to manufacture components in the field of safety (for example impact absorbing devices installed in cars), or the packaging sector, where they are used to provide coarse containers for the transport of semifinished parts and the like.

Currently, the process for molding expanded thermoplastic polymers occurs by using injection presses, on which appropriate molds are mounted which are adapted to give the desired shape and dimensions to the provided manufactured articles.

In general, known injection presses for molding expanded thermoplastic polymers have: a compressed air injection system, which is adapted to inject the expanded thermoplastic polymer into said molds, in the form of pellets having a variable diameter; a steam dispensing system, which is adapted to sinter the expanded thermoplastic polymer being processed; a system for dispensing cooling water, which is adapted to stabilize the expanded thermoplastic polymer being processed; and a vacuum system.

Known molds are made of metallic materials, such as for example aluminum, and are characterized in that they are completely perforated, i.e., they comprise a large number of small holes which are distributed more or less uniformly over their entire surface or on a large part of it.

These small holes, distributed on the surface of known molds, allow the passage of steam and cooling water, which are dispensed by the corresponding systems during processing.

Steam and cooling water are the elements that are needed for the sintering and subsequent stabilization of the expanded thermoplastic polymer being processed, injected previously in the corresponding known molds in the form of pellets.

In polymer technology, and in particular in the field of the corresponding molding processes, sintering is an operation that is performed in order to obtain compact manufactured articles starting from polymeric materials in the form of pellets, which are normally subjected simultaneously both to mechanical treatments (pressure) and to thermal treatments (heating).

These compact manufactured articles obtained from sintering have a shape and dimensions which are determined by the molds used, have preset physical and mechanical characteristics, and have properties that are similar to those of manufactured articles obtained for example by total melting and pouring into a mold.

However, the solutions of the known kind described above are not free from drawbacks, which include the fact that the manufactured articles, obtained by means of known presses and/or known processes for molding expanded thermoplastic polymers, have a coarse and inadequate surface finish, appearing to the users as rough and porous, both externally and internally.

For this reason, particularly in the case of manufactured articles designed to last over time and which must be easy to clean, these manufactured articles made of expanded thermoplastic polymers are commonly covered, after their molding, with other materials of a different kind, such as for example fabrics or plastic and/or metallic preforms provided beforehand.

The aim of the present invention is to overcome the limitations of the background art described above, by providing a press and a method for molding expanded thermoplastic polymers that allow to obtain effects that are similar to, or better than, those obtainable with known solutions, allowing to provide manufactured articles made of expanded thermoplastic polymers that have a hard and compact surface covering layer, fully or partially covering the surface of said manufactured articles.

Within this aim, an object of the present invention is to conceive a press and a method for molding expanded thermoplastic polymers that allow to provide manufactured articles that have a hard and compact surface covering layer with different degrees of surface finish, for example smooth or rough, in any case being pleasant to the touch for users.

Another object of the present invention is to devise a press and a method for molding expanded thermoplastic polymers that allow to provide manufactured articles that have a hard and compact surface covering layer, keeping unchanged the specific characteristics of the internal part of said manufactured articles, in particular softness and elasticity.

A further object of the present invention is to conceive a press and a method for molding expanded thermoplastic polymers that allow to provide manufactured articles that have a hard and compact surface covering layer that makes them durable over time.

Another object of the present invention is to devise a press and a method for molding expanded thermoplastic polymers that allow to provide manufactured articles that have a hard and compact surface covering layer that facilitates their cleaning.

A further object of the present invention is to provide a press and a method for molding expanded thermoplastic polymers that are highly reliable, relatively simple to provide and at modest costs.

This aim, as well as these and other objects which will become better apparent hereinafter, are achieved by a press for molding expanded thermoplastic polymers, comprising at least one portion comprising a fixed plane with a first chamber and a movable plane with a chamber, said fixed plane and said movable plane comprising at least one male mold part and at least one female mold part, which form at least one cavity upon closure, said press being characterized in that said fixed plane of said at least one portion comprises, in a second chamber obtained inside said first chamber, a duct for dispensing steam inside said second chamber, adapted to superheat said at least one male mold part and/or said at least one female mold part, and a duct for dispensing water inside said second chamber, adapted to cool said at least one male mold part and/or said at least one female mold part, and a condensation discharge duct.

The intended aim and objects are also achieved by a method for molding expanded thermoplastic polymers, characterized in that it comprises the steps that consist in: closing and compressing against each other at least one male mold part and at least one female mold part, forming at least one cavity upon closure; dispensing steam, superheating said at least one male mold part and/or said at least one female mold part; dispensing cooling water, cooling said at least one male mold part and/or said at least one female mold part; opening said at least one male mold part and said at least one female mold part; extracting at least one obtained manufactured article.

Further characteristics and advantages of the invention will become better apparent from the description of some preferred but not exclusive embodiments of the press and of the method for molding expanded thermoplastic polymers according to the invention, illustrated by way of non-limiting example in the accompanying drawings, wherein:

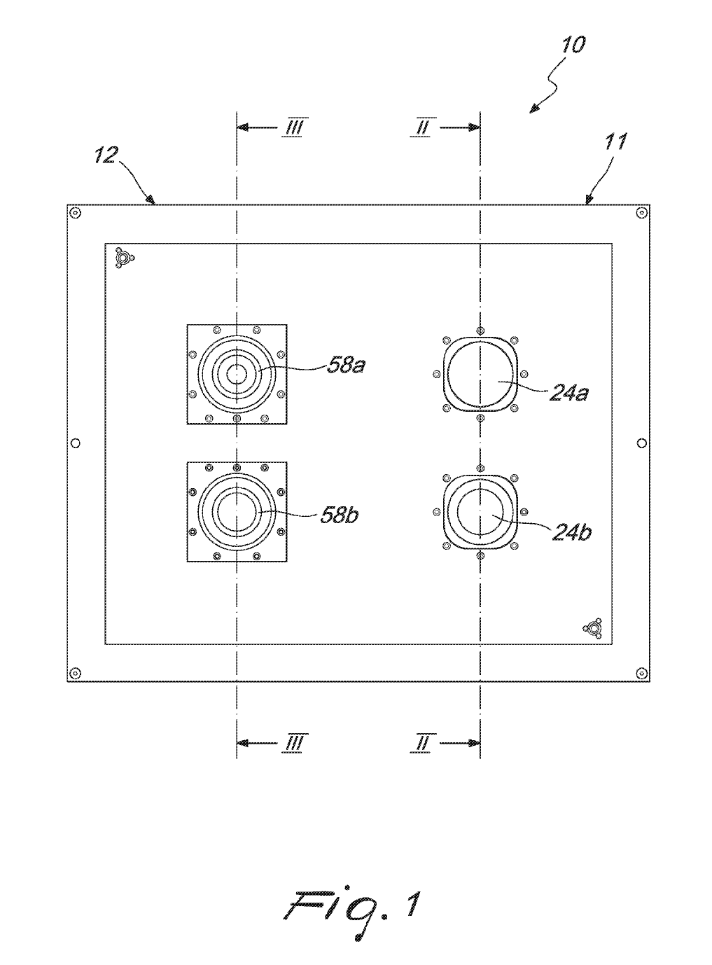

FIG. 1 is a simplified top view of a first embodiment of the press for molding expanded thermoplastic polymers, according to the present invention;

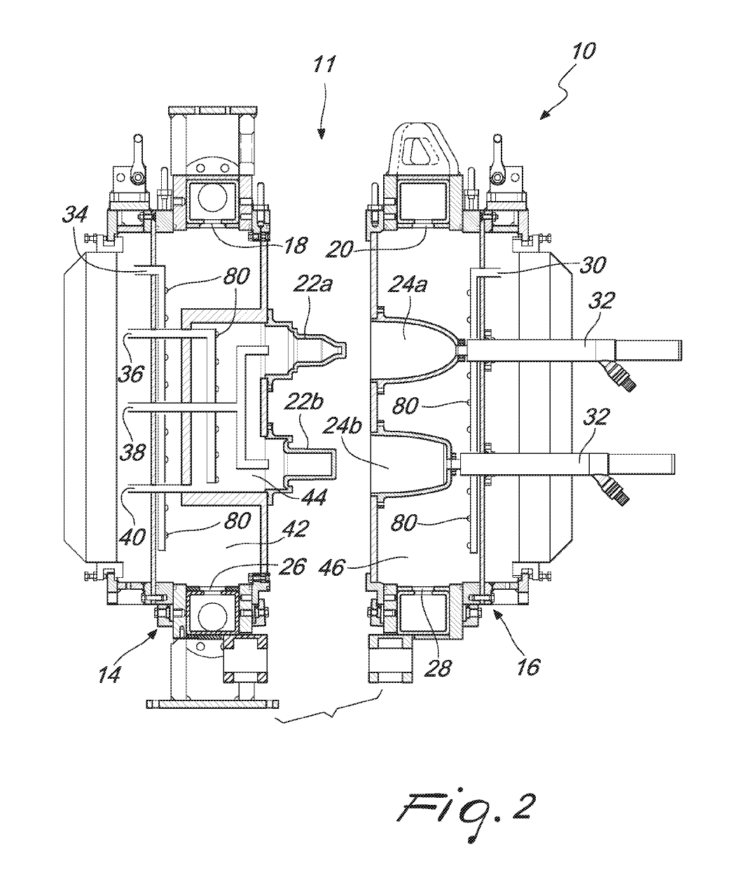

FIG. 2 is a vertical sectional view of a first portion of the first embodiment of the press for molding expanded thermoplastic polymers, according to the present invention, shown in FIG. 1;

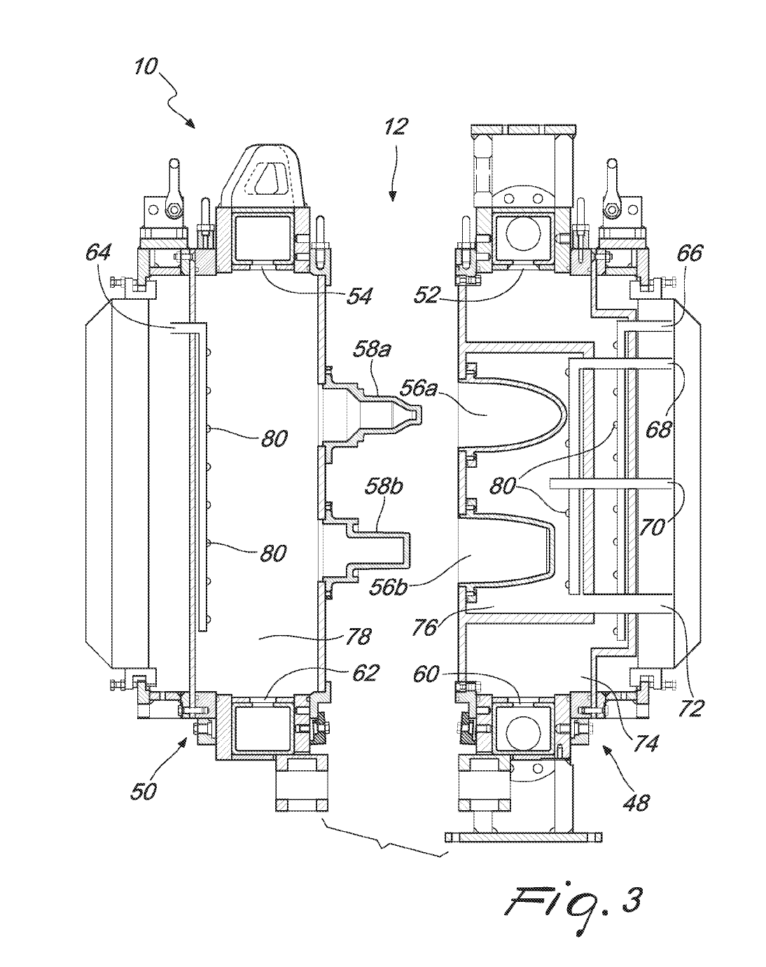

FIG. 3 is a vertical sectional view of a second portion of the first embodiment of the press for molding expanded thermoplastic polymers, according to the present invention, shown in FIG. 1;

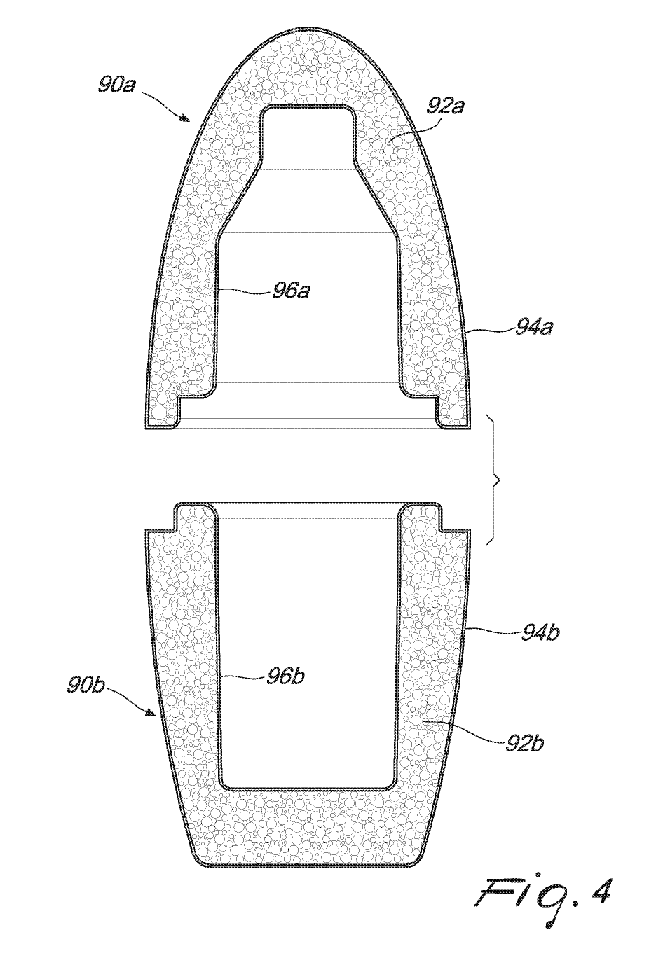

FIG. 4 is a vertical sectional view of a first manufactured article and of a second manufactured article, both obtained by using the first embodiment of the press for molding expanded thermoplastic polymers, according to the present invention, shown in FIGS. 1, 2 and 3;

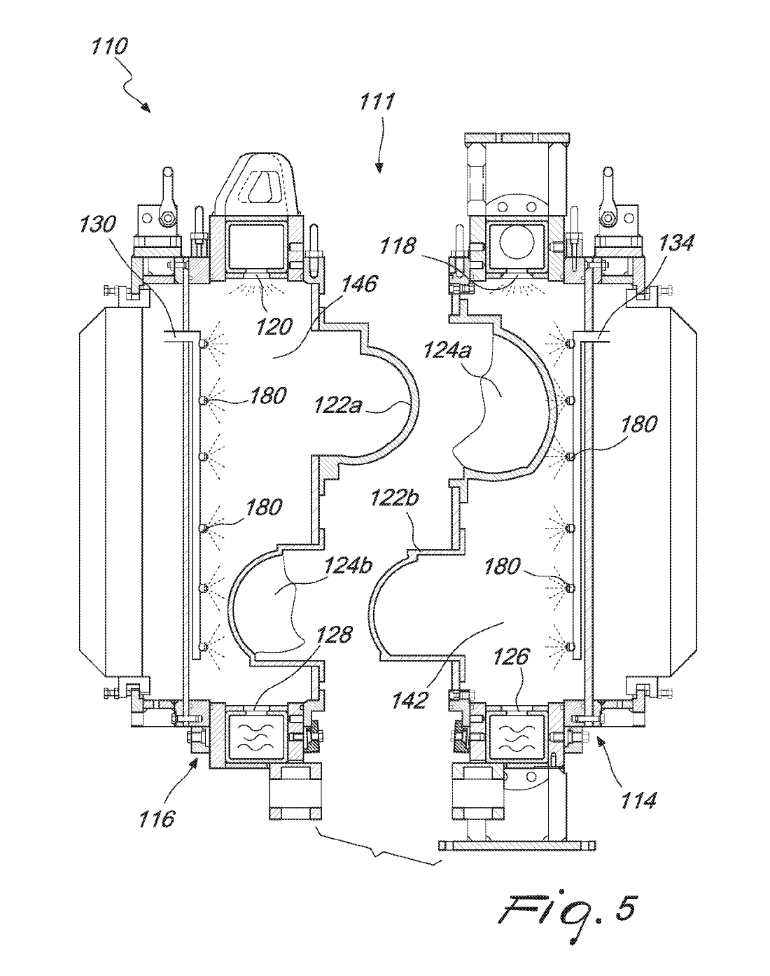

FIG. 5 is a vertical sectional view of a first portion of a second embodiment of the press for molding expanded thermoplastic polymers, according to the present invention;

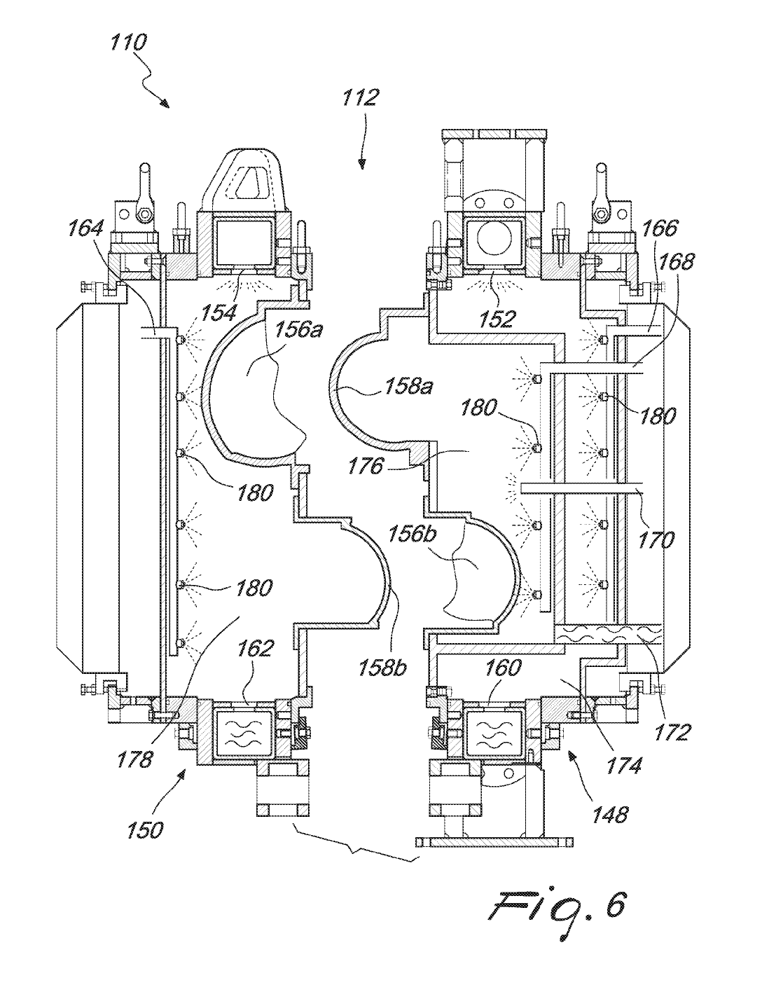

FIG. 6 is a vertical sectional view of a second portion of a second embodiment of the press for molding expanded thermoplastic polymers, according to the present invention.

With reference to FIGS. 1-4, the press for molding expanded thermoplastic polymers according to the invention, designated generally by the reference numeral 10, comprises substantially a first portion 11 and a second portion 12: the first portion 11 of the press 10 comprises a first portion of the fixed plane 14, to which at least one male mold part or plug 22a, 22b is fixed, and a first portion of the movable plane 16, to which at least one female mold part or impression 24a, 24b is fixed; the second portion 12 of the press 10 comprises a second portion of the fixed plane 48, to which at least one female mold part or impression 56a, 56b is fixed, and a second portion of the movable plane 50, to which at least one male mold part or plug 58a, 58b is fixed.

The male mold parts 22a and 22b, the female mold parts 24a and 24b, the female mold parts 56a and 56b, and the male mold parts 58a and 58b are made of metallic materials, such as for example aluminum, and have a surface that is entirely free from holes, except for the female mold parts 24a and 24b, each of which has a hole provided on the bottom and in a central position, through which it is possible to load the female mold parts 24a and 24b with an expanded thermoplastic polymer in the form of pellets, i.e., introduce therein the raw material to be processed.

In a preferred embodiment of the press 10 according to the invention, each of the female mold parts 24a and 24b is connected, at said hole, to a high-pressure injector 32, which will be discussed in the continuation of the present description.

It should be noted that the first portion 11 and the second portion 12 of the press 10 according to the invention are mutually associated or are rigidly coupled to each other. In practice, the press 10 comprises a single fixed plane, in a lower position and constituted by the corresponding first portion 14 and second portion 48, and a single movable plane, in an upper position and constituted by the corresponding first portion 16 and second portion 50.

Therefore, for example, if the fixed plane 14 and the movable plane 16 of the first portion 11 of the press 10 close against each other, the fixed plane 48 and the movable plane 50 of the second portion 12 of the press 10 also close against each other.

The fixed plane 14 of the first portion 11 of the press 10 for molding expanded thermoplastic polymers according to the invention comprises a first chamber 42, which is provided with a steam inlet 18 and a condensation drain 26, the latter being in an opposite position with respect to the steam inlet 18, as well as a duct 34 for dispensing cooling water, provided with atomizing nozzles 80.

Inside the first chamber 42 of the fixed plane 14 there is a second chamber 44, which is therefore smaller than the first chamber 42. The male mold parts 22a and 22b are fitted at this second chamber 44.

The second chamber 44 of the fixed plane 14 is provided with a duct 36, provided with atomizing nozzles 80, for dispensing water inside the second chamber 44, in particular in the male mold parts 22a and 22b, the duct 36 for dispensing water being adapted to cool them.

The second chamber 44 of the fixed plane 14 is provided furthermore with a duct 38 for dispensing steam inside the second chamber 44, in particular in the male mold parts 22a and 22b, the duct 38 for dispensing steam being adapted to superheat them.

The second chamber 44 of the fixed plane 14 is provided, finally, with a condensation drain duct 40, which is adapted to drain outside the second chamber 44 the fluids produced by the activity of the ducts 36 and 38.

The heating of the male mold parts 22a and 22b allows the surface melting of the expanded thermoplastic polymer in contact with the male mold parts 22a and 22b, while the cooling of the male mold parts 22a and 22b allows the subsequent crystallization of the internal surface 96a, 96b of the obtained manufactured articles 90a and 90b, and the consequent forming of a corresponding hard and compact internal surface covering layer.

The movable plane 16 of the first portion 11 of the press 10 for molding expanded thermoplastic polymers according to the invention comprises a chamber 46, at which the female mold parts 24a and 24b are fitted.

This chamber 46 of the movable plane 16 is provided with a steam inlet 20 and a condensation drain 28, the latter being in an opposite position with respect to the steam inlet 20, as well as a duct 30 for dispensing cooling water, provided with atomizing nozzles 80.

The movable plane 16 of the first portion 11 of the press 10 comprises furthermore a high-pressure injector 32 connected to each of the female mold parts 24a and 24b, the high-pressure injector 32 being adapted to load the female mold parts 24a and 24b with an expanded thermoplastic polymer in the form of pellets.

The fixed plane 48 of the second portion 12 of the press 10 for molding expanded thermoplastic polymers according to the invention comprises a first chamber 74, which is provided with a steam inlet 52 and a condensation drain 60, the latter being in an opposite position with respect to the steam inlet 52, as well as a duct 66 for dispensing cooling water, provided with atomizing nozzles 80.

Inside the first chamber 74 of the fixed plane 48 there is a second chamber 76, which is therefore smaller than the first chamber 74. The female mold parts 56a and 56b are fitted at this second chamber 76.

The second chamber 76 of the fixed plane 48 is provided with a duct 68, provided with atomizing nozzles 80, for dispensing water inside the second chamber 76, in particular onto the female mold parts 56a and 56b, the duct 68 for dispensing water being adapted to cool them.

The second chamber 76 of the fixed plane 48 is provided furthermore with a duct 70 for dispensing steam inside the second chamber 76, in particular onto the female mold parts 56a and 56b, the duct 70 for dispensing steam being adapted to superheat them.

Finally, the second chamber 76 of the fixed plane 48 is provided with a condensation drain duct 72, adapted to drain outside the second chamber 76 the fluids produced by the activity of the ducts 68 and 70.

The heating of the female mold parts 56a and 56b allows the surface melting of the expanded thermoplastic polymer in contact with the female mold parts 56a and 56b, while the cooling of the female mold parts 56a and 56b allows the subsequent crystallization of the external surface 94a, 94b of the obtained manufactured articles 90a and 90b, and the consequent forming of a corresponding hard and compact external surface covering layer.

The movable plane 50 of the second portion 12 of the press 10 for molding expanded thermoplastic polymers according to the invention comprises a chamber 78, at which the male mold parts 58a and 58b are fitted.

This chamber 78 of the movable plane 50 is provided with a steam inlet 54 and a condensation drain 62, the latter being in an opposite position with respect to the steam inlet 54, as well as a duct 64 for dispensing cooling water, provided with atomizing nozzles 80.

In a first variation of a different embodiment of the invention, the press 10 for molding expanded thermoplastic polymers con be configured so that the duct 38, 70 for dispensing steam inside the second chamber 44, 76 of the fixed plane 14, 48 is present only in the first portion 11, in particular in the second chamber 44 of the fixed plane 14, thus obtaining the crystallization only of the internal surface 96a, 96b of the manufactured articles 90a and 90b.

As an alternative, in a second variation of a different embodiment of the invention, the press 10 for molding expanded thermoplastic polymers can be configured so that the duct 38, 70 for dispensing steam inside the second chamber 44, 76 of the fixed plane 14, 48 is present only in the second portion 12, in particular in the second chamber 76 of the fixed plane 48, thus obtaining the crystallization only of the external surface 94a, 94b of the manufactured articles 90a and 90b.

In a first variation of another different embodiment of the invention, the press 10 for molding expanded thermoplastic polymers can comprise only the first portion 11, which comprises the fixed plane 14 and the movable plane 16, thus obtaining the crystallization only of the internal surface 96a, 96b of the manufactured articles 90a and 90b.

As an alternative, in a second variation of another different embodiment of the invention, the press 10 for molding expanded thermoplastic polymers can comprise only the second portion 12, which comprises the fixed plane 48 and the movable plane 50, thus obtaining the crystallization only of the external surface 94a, 94b of the manufactured articles 90a and 90b.

In both cases, the press 10 according to the invention must also comprise high-pressure injectors 32, in the first case connected to the female mold parts 24a and 24b and in the second case connected to the female mold parts 56a and 56b.

In a preferred embodiment of the press 10 for molding expanded thermoplastic polymers according to the invention, the volume V_{f} of the cavities formed upon closure in the second portion 12 of the press 10, between the female mold part 56a and the male mold part 58a, and between the female mold part 56b and the male mold part 58b, is smaller than the volume Vᵢ of the cavities formed upon closure in the first portion 11 of the press 10, between the male mold part 22a and the female mold part 24a, and between the male mold part 22b and the female mold part 24b.

In particular, the cavities of the second portion 12 of the press 10 have a smaller volume V_{f} that is predefined and calculated in each instance as needed, in proportion to the larger volume Vᵢ of the cavities of the first portion 11 of the press 10.

The difference in volume V_{c} between the volume Vᵢ of the cavities of the first portion 11 and the volume V_{f} of the cavities of the second portion 12 of the press 10 corresponds to the volume of the expanded thermoplastic polymer which will melt and then crystallize following contact with the female mold parts 56a and 56b, first superheated and then cooled.

Furthermore, said difference in volume V_{c} corresponds to an offset of a few millimeters in thickness outward in the case of manufactured articles 90a, 90b with a crystallized outer surface covering layer, to an offset of a few millimeters in thickness inward in the case of manufactured articles 90a, 90b with an internal layer of crystallized surface covering, or both in the case of manufactured articles 90a, 90b with a crystallized outer and inner surface covering layer.

Therefore, the volume of the crystallized surface covering layer obtained is smaller than volume V_{c} of the expanded thermoplastic polymer that has melted and then crystallized, and the manufactured articles 90a and 90b obtained have a final volume V_{f} that is smaller than the initial volume Vᵢ of the semifinished manufactured articles 90a and 90b that exit from the first portion 11 of the press 10.

In an embodiment of the invention, the press 10 for molding expanded thermoplastic polymers can comprise furthermore a footing for supporting the press 10 and a support and guiding system for the movable plane 16, 50, both not shown. The support and guiding system can comprise, for example, four cylindrical columns.

In an embodiment of the invention, the press 10 for molding expanded thermoplastic polymers can comprise furthermore a closure mechanism, not shown, which is adapted to close and compress the movable plane 16, 50 against the fixed plane 14, 48; and consequently close and compress the male mold part 22a with the female mold part 24a, the male mold part 22b with the female mold part 24b, the female mold part 56a with the male mold part 58a, the female mold part 56b with the male mold part 58b, forming a respective cavity upon closure. The closure mechanism can comprise, for example, one more more toggles actuated by hydraulic actuators.

In an embodiment of the invention, the press 10 for molding expanded thermoplastic polymers can comprise furthermore a hydraulic controller, not shown, which is adapted to supply mechanical energy for the actuations of the hydraulic actuators.

In an embodiment of the invention, the press 10 for molding expanded thermoplastic polymers can comprise furthermore a system for the automatic, manual or assisted extraction of the processed manufactured articles, for example of a mechanical type for simpler manufactured articles or of the hydraulic type for more complex or delicate manufactured articles.

In an embodiment of the invention, the press 10 for molding expanded thermoplastic polymers can comprise furthermore an electronic control unit, not shown, suitable for data entry and suitable to manage and supervise working and the operations of the molding cycle of the press 10.

Operation of the press 10 for molding expanded thermoplastic polymers according to the invention is as follows.

As a preliminary, the male mold parts 22a and 22b are fitted at the second chamber 44 of the fixed plane 14 of the first portion 11 of the press 10; the female mold parts 24a and 24b are fitted at the chamber 46 of the movable plane 16 of the first portion 11 of the press 10; the female mold parts 56a and 56b are fitted at the second chamber 76 of the fixed plane 48 of the second portion 12 of the press 10; and the male mold parts 58a and 58b are fitted at the chamber 78 of the movable plane 50 of the second portion 12 of the press 10. Furthermore, the female mold parts 24a and 24b are connected to the respective high-pressure injectors 32 of expanded thermoplastic polymers.

After the fitting of the mold parts and the connection of the injectors of expanded thermoplastic polymers, in the fixed plane 14 of the first portion 11 of the press 10, the following are connected to the corresponding systems: the steam inlet 18, the condensation drain 26, the duct 34 for dispensing cooling water inside the first chamber 42, the duct 36 for dispensing cooling water in the male mold parts 22a and 22b, the duct 38 for dispensing steam in the male mold parts 22a and 22b, and the corresponding condensation drain duct 40.

Likewise, in the movable plane 16 of the first portion 11 of the press 10, the following are connected to the corresponding systems: the steam inlet 20, the condensation drain 28, and the duct 30 for dispensing cooling water inside the chamber 46.

Moreover, in the fixed plane 48 of the second portion 12 of the press 10, the following are connected to the corresponding systems: the steam inlet 52, the condensation drain 60, the duct 66 for dispensing cooling water inside the first chamber 74, the duct 68 for dispensing cooling water on the female mold parts 56a and 56b, the duct 70 for dispensing steam on the female mold parts 56a and 56b, and the corresponding condensation drain duct 72.

Finally, in the movable plane 50 of the second portion 12 of the press 10, the following are connected to the corresponding systems: the steam inlet 54, the condensation drain 62, and the duct 64 for dispensing cooling water inside the chamber 78.

Initially, the fixed plane 14 and the movable plane 16 of the first portion 11 of the press 10 close against each other, with a high compression provided by the hydraulic actuators of the movable plane 16; consequently, the male mold part 22a closes and compresses with the female mold part 24a and the male mold part 22b closes and compresses with the female mold part 24b, forming a respective cavity upon closure. In particular, during this step, the expanded thermoplastic polymer being processed is subjected to a compression preferably comprised between 9 bar and 11 bar, even more preferably equal to 10 bar.

In the second chamber 44 of the fixed plane 14, i.e., in the male mold parts 22a and 22b, steam is dispensed by means of the duct 38, at a pressure preferably comprised between 5.5 bar and 6.5 bar, even more preferably equal to 6 bar, so that the male mold parts 22a and 22b superheat to a temperature preferably comprised between 150° C. and 170° C., even more preferably equal to 160° C.

At this point, the press 10 is loaded with an expanded thermoplastic polymer in the form of pellets, filling the cavities formed upon closure in the first portion 11 of the press 10, between the male mold part 22a and the female mold part 24a, and between the male mold part 22b and the female mold part 24b.

In a preferred embodiment of the method according to the invention, the expanded thermoplastic polymer in the form of pellets is injected at high pressure in the female mold parts 24a and 24b, by means of the respective high-pressure injectors 32.

The freshly loaded expanded thermoplastic polymer thus makes contact with the superheated surfaces of the male mold parts 22a and 22b, and melts superficially for a thickness preferably comprised between 0.8 mm and 1.2 mm, even more preferably equal to 1 mm, while the remaining part or core 92a, 92b of the expanded thermoplastic polymer, below the melted surface 96a, 96b, sinters by virtue of the steam dispensed in the chamber 46 onto the female mold parts 24a and 24b, at a pressure preferably comprised between 2.5 bar and 3.5 bar, even more preferably equal to 3 bar, by means of the steam inlet 20 of the movable plane 16 of the first portion 11 of the press 10.

The melting of the surface of the expanded thermoplastic polymer in contact with the superheated male mold parts 22a and 22b allows the subsequent crystallization, by cooling, of the internal surface 96a, 96b of the manufactured articles 90a and 90b thus obtained, and the consequent forming of a corresponding hard and compact internal surface covering layer.

During the operations for crystallization of the internal surface 96a, 96b of the manufactured articles 90a, 90b made of expanded thermoplastic polymer, the condensation drain duct 40 remains open to allow the outflow of condensation from the second chamber 44 of the fixed plane 14 of the first portion 11 of the press 10.

After reaching the correct crystallization of the internal surface 96a, 96b of the manufactured articles 90a and 90b, as well as the correct sintering of the non-superficial part or core 92a, 92b of the manufactured articles 90a and 90b, cooling water is atomized by means of the corresponding ducts 34, 36 and 30, respectively in the first chamber 42 of the fixed plane 14, in the second chamber 44 of the fixed plane 14, i.e., in the male mold parts 22a and 22b, and in the chamber 46 of the movable plane 16, i.e., onto the female mold parts 24a and 24b.

The cooling water dispensed by the duct 36 has priority with respect to other water and becomes active directly after the loading of the expanded thermoplastic polymer in the female mold parts 24a and 24b, so as to avoid harmful overheatings of said expanded thermoplastic polymer.

At the same time, the condensation drains 26 and 28 are opened to allow the outflow of condensation respectively from the first chamber 42 of the fixed plane 14 and from the chamber 46 of the movable plane 16 of the first portion 11 of the press 10.

The fixed plane 14 and the movable plane 16 of the first portion 11 of the press 10 then open, and the partially processed manufactured articles 90a and 90b obtained so far, which have only the internal surface 96a, 96b crystallized, are extracted automatically or manually from the male mold parts 22a and 22b, respectively, of the fixed plane 14 of the first portion 11 of the press 10.

At this point, the partially processed manufactured articles 90a and 90b that exit from the first portion 11 of the press 10 can be crystallized on the remaining external surface 94a, 94b, which is opposite with respect to the internal surface 96a, 96b of the manufactured articles 90a and 90b previously crystallized and converted into a hard and compact surface covering layer.

By keeping open the fixed plane 14 and the movable plane 16 of the first portion 11 of the press 10, and therefore keeping open also the fixed plane 48 and the movable plane 50 of the second portion 12 of the press 10, the partially processed manufactured articles 90a and 90b obtained so far, in which only the internal surface 96a and 96b is crystallized, are arranged automatically or manually on the male mold parts 58a and 58b, respectively, of the movable plane 50 of the second portion 12 of the press 10.

The fixed plane 48 and the movable plane 50 of the second portion 12 of the press 10 then close against each other, with a high compression produced by the hydraulic actuators of the movable plane 50; consequently, the female mold part 56a closes and compresses with the male mold part 58a, and the female mold part 56b closes and compresses with the male mold part 58b, forming a respective cavity upon closure. In particular, during this step, the expanded thermoplastic polymer being processed is subjected to a compression preferably comprised between 9 bar and 11 bar, even more preferably equal to 10 bar.

In the second chamber 76 of the fixed plane 48, i.e., on the female mold parts 56a and 56b, steam is dispensed by means of the duct 70, at a pressure preferably comprised between 5.5 bar and 6.5 bar, even more preferably equal to 6 bar, so that the female mold parts 56a and 56b are superheated to a temperature preferably comprised between 150° C. and 170° C., even more preferably equal to 160° C.

The expanded thermoplastic polymer of the partially processed manufactured articles 90a and 90b thus makes contact with the superheated surfaces of the female mold parts 56a and 56b, and melts superficially for a thickness preferably comprised between 0.8 mm and 1.2 mm, even more preferably equal to 1 mm, while the remaining part or core 92a, 92b of the expanded thermoplastic polymer, below the melted surface 94a, 94b, sinters by virtue of the steam dispensed in the male mold parts 58a and 58b, at a pressure preferably comprised between 2.5 bar and 3.5 bar, even more preferably equal to 3 bar, by means of the steam inlet 54 of the movable plane 50 of the second portion 12 of the press 10.

The melting of the surface of the expanded thermoplastic polymer in contact with the superheated female mold parts 56a and 56b allows the subsequent crystallization, by cooling, of the external surface 94a, 94b of the manufactured articles 90a and 90b thus obtained, and the consequent forming of a corresponding hard and compact external surface covering layer.

During the crystallization of the external surface 94a, 94b of the manufactured articles 90a, 90b made of expanded thermoplastic polymer thus obtained, the condensation drain duct 72 remains open to allow the outflow of condensation from the second chamber 76 of the fixed plane 48 of the second portion 12 of the press 10.

After achieving correct crystallization of the external surface 94a, 94b of the manufactured articles 90a and 90b, as well as the correct sintering of the non-superficial part or core 92a, 92b of the manufactured articles 90a and 90b, cooling water is atomized by means of the corresponding ducts 66, 68 and 64, respectively in the first chamber 74 of the fixed plane 48, in the second chamber 76 of the fixed plane 48, i.e., on the female mold parts 56a and 56b, and in the chamber 78 of the movable plane 50, i.e., in the male mold parts 58a and 58b.

The cooling water dispensed by the duct 68 has priority over other water and becomes active a preset time after the closure of the fixed plane 48 and of the movable plane 50 of the second portion 12 of the press 10, so as to avoid damaging superheatings of the expanded thermoplastic polymer.

At the same time, the condensation drains 60 and 62 are opened to allow the outflow of condensation respectively from the first chamber 74 of the fixed plane 48 and from the chamber 78 of the movable plane 50 of the second portion 12 of the press 10.

Finally, the fixed plane 48 and the movable plane 50 of the second portion 12 of the press 10 open, and the manufactured articles 90a and 90b thus obtained and ready for use, provided with the crystallized internal surface 96a, 96b and external surface 94a, 94b, are extracted automatically or manually from the male mold parts 58a and 58b, respectively, of the movable plane 50 of the second portion 12 of the press 10.

Therefore, the manufactured articles 90a and 90b thus obtained, once processing has ended, have a core 92a, 92b made of sintered expanded thermoplastic polymer and a hard and compact surface covering layer at their visible surfaces, in particular at their internal surface 96a, 96b and at their external surface 94a, 94b, said surface covering being obtained by crystallization of the expanded thermoplastic polymer.

It should be noted that the thickness of the layer of crystallized surface covering can vary according to the density and type of expanded thermoplastic polymer used as raw material, to the crystallization temperatures and pressures, as well as to the applied compression force.

In a first variation of a different embodiment of the invention, the method for molding expanded thermoplastic polymers can provide for the crystallization of the surface of the expanded thermoplastic polymer only in the first portion 11 of the press 10, at the male mold parts 22a and 22b fitted in the second chamber 44 of the fixed plane 14, thus obtaining the crystallization only of the internal surface 96a, 96b of the manufactured articles 90a and 90b.

As an alternative, in a second variation of a different embodiment of the invention, the method for molding expanded thermoplastic polymers can provide for the crystallization of the surface of the expanded thermoplastic polymer only in the second portion 12 of the press 10, at the female mold parts 56a and 56b fitted in the second chamber 76 of the fixed plane 48, thus obtaining the crystallization only of the external surface 94a, 94b of the manufactured articles 90a and 90b.

In a first variation of another different embodiment of the invention, the method for molding expanded thermoplastic polymers can provide only the steps for processing the expanded thermoplastic polymer performed in the first portion 11 of the press 10, thus obtaining the crystallization only of the internal surface 96a, 96b of the manufactured articles 90a and 90b.

As an alternative, in a second variation of another different embodiment of the invention, the method for molding expanded thermoplastic polymers can provide only the steps for processing the expanded thermoplastic polymer performed in the second portion 12, thus obtaining the crystallization only of the external surface 94a, 94b of the manufactured articles 90a and 90b.

In both cases, the method according to the invention must provide for the loading of the expanded thermoplastic polymer used as raw material, in the first case in the female mold parts 24a and 24b, and in the second case in the female mold parts 56a and 56b.

In a preferred embodiment of the method for molding expanded thermoplastic polymers according to the invention, the volume V_{f} of the cavities formed upon closure between the female mold part 56a and the male mold part 58a, and between the female mold part 56b and the male mold part 58b, during the step for closure and compression of the fixed plane 48 and of the movable plane 50 of the second portion 12 of the press 10, is smaller than the volume Vᵢ of the cavities formed upon closure between the male mold part 22a and the female mold part 24a, and between the male mold part 22b and the female mold part 24b, during the step for closure and compression of the fixed plane 14 and of the movable plane 16 of the first portion 11 of the press 10.

In particular, the cavities of the second portion 12 of the press 10 have a predefined smaller volume V_{f}, calculated in each instance, depending on the requirements of the specific case, in proportion to the larger volume Vᵢ of the cavities of the first portion 11 of the press 10.

The difference in volume V_{c} between the volume Vᵢ of the cavities of the first portion 11 and the volume V_{f} of the cavities of the second portion 12 of the press 10 corresponds to the volume of the expanded thermoplastic polymer that will melt and then crystallize following contact with the female mold parts 56a and 56b, which are first superheated and then cooled.

Furthermore, said difference in volume V_{c} corresponds to an offset of a few millimeters of thickness outward in the case of manufactured articles 90a, 90b with a crystallized outer surface covering layer, to an offset of a few millimeters in thickness inward in the case of manufactured articles 90a, 90b with a crystallized inner surface covering layer, or both in the case of manufactured articles 90a, 90b with a crystallized outer and inner surface covering layer.

Therefore, the volume of the layer of crystallized surface covering that is obtained is smaller than the volume V_{c} of the expanded thermoplastic polymer that has melted and then crystallized, and the manufactured articles 90a and 90b obtained have a final volume V_{f} that is smaller than the initial volume Vᵢ of the partially processed manufactured articles 90a and 90b that exit from the first portion 11 of the press 10.

The applications of the press and of the method for molding expanded thermoplastic polymers according to the invention are several. By way of example, a preferred embodiment of the method for molding expanded thermoplastic polymers according to the invention can be provided for the production of inner shells, or protective paddings, for helmets. Likewise, a preferred embodiment of the press for molding expanded thermoplastic polymers according to the invention can be configured for the production of inner shells, or protective paddings, for helmets. In this way, the impact resistance characteristic of expanded thermoplastic polymers is utilized to obtain protective helmets of various kinds.

In general, the helmet is a protective head covering, used both in the motoring field (for example helmet for motorcyclists and for sports car drivers) and in the field of sports (for example helmets for cyclists and for American football players), and in the field of work (for example helmets for construction workers), in order to spare and protect the head of the user who wears it against sudden impacts.

With reference to FIGS. 5 and 6, the press for molding expanded thermoplastic polymers according to the invention, generally designated by the reference numeral 110, comprises substantially a first portion 111 and a second portion 112: the first portion 111 of the press 110 comprises a first portion of the fixed plane 114, to which at least one male mold part or plug 122b and at least one female mold part or impression 124a are fixed, and a first portion of the movable plane 116, to which at least one male mold part or plug 122a and at least one female mold part or impression 124b are fixed; the second portion 112 of the press 110 comprises a second portion of the fixed plane 148, to which at least one female mold part or impression 156b and at least one male mold part or plug 158a are fixed, and a second portion of the movable plane 150, to which at least one female mold part or impression 156a and at least one male mold part or plug 158b are fixed.

The male mold parts 122a and 122b, the female mold parts 124a and 124b, the female mold parts 156a and 156b, and the male mold parts 158a and 158b are made of metallic materials, such as for example aluminum, and have a surface that is entirely free from holes.

In a first variation of the embodiment of the press 110 according to the invention, the first portion 111 and the second portion 112 are mutually associated or are rigidly coupled to each other. In practice, the press 110 comprises a single fixed plane, in a lower position and constituted by the corresponding first portion 114 and second portion 148, and a single movable plane, in an upper position and constituted by the corresponding first portion 116 and second portion 150.

In a second variation of the embodiment of the press 110 according to the invention, the first portion 111 and the second portion 112 are not mutually associated, i.e., they are mutually independent.

The fixed plane 114 of the first portion 111 of the press 110 for molding expanded thermoplastic polymers according to the invention comprises a chamber 142, at which the male mold part 122b and female mold part 124a are fitted.

This chamber 142 of the fixed plane 114 is provided with a steam inlet 118 and a condensation drain 126, the latter being in an opposite position with respect to the steam inlet 118, as well as a duct 134 for dispensing cooling water, provided with atomizing nozzles 180.

The movable plane 116 of the first portion 111 of the press 110 for molding expanded thermoplastic polymers according to the invention comprises a chamber 146, at which the male mold part 122a and female mold part 124b are fitted.

This chamber 146 of the movable plane 116 is provided with a steam inlet 120 and a condensation drain 128, the latter being in an opposite position with respect to the steam inlet 120, as well as a duct 130 for dispensing cooling water, provided with atomizing nozzles 180.

The fixed plane 148 of the second portion 112 of the press 110 for molding expanded thermoplastic polymers according to the invention comprises a first chamber 174, which is provided with a steam inlet 152 and a condensation drain 160, the latter being in an opposite position with respect to the steam inlet 152, as well as a duct 166 for dispensing cooling water, provided with atomizing nozzles 180.

Inside the first chamber 174 of the fixed plane 148 there is a second chamber 176, which is therefore smaller than the first chamber 174. The female mold part 156b and male mold part 158a are fitted at this second chamber 176.

The second chamber 176 of the fixed plane 148 is provided with a duct 168, provided with atomizing nozzles 180, for dispensing water inside the second chamber 176, in particular on the female mold part 156b and male mold part 158a, the duct 168 for dispensing water being adapted to cool the latter mold parts.

The second chamber 176 of the fixed plane 148 is provided, furthermore, with a duct 170 for dispensing steam inside the second chamber 176, in particular on the female mold part 156b and male mold part 158a, the duct 170 for dispensing steam being adapted to superheat the latter mold parts.

The second chamber 176 of the fixed plane 148 is provided, finally, with a condensation drain duct 172, which is adapted to drain outside the second chamber 176 the fluids produced by the activity of the ducts 168 and 170.

The heating of the female mold part 156b and male mold part 158a allows the surface melting of the expanded thermoplastic polymer in contact with the female mold part 156b and male mold part 158a, while the cooling of the female mold part 156b and male mold part 158a allows the subsequent crystallization of the external surface and internal surface, respectively, of the inner shells for helmets thus obtained, and the consequent forming of a corresponding hard and compact external surface covering layer.

The movable plane 150 of the second portion 112 of the press 110 for molding expanded thermoplastic polymers according to the invention comprises a chamber 178, at which the female mold part 156a and male mold part 158b are fitted.

This chamber 178 of the movable plane 150 is provided with a steam inlet 154 and a condensation drain 162, the latter being in an opposite position with respect to the steam inlet 154, as well as a duct 164 for dispensing cooling water, provided with atomizing nozzles 180.

In a preferred embodiment of the press 110 for molding expanded thermoplastic polymers according to the invention, the volume V_{f} of the cavities formed upon closure in the second portion 112 of the press 110, between the female mold part 156a and the male mold part 158a, and between the female mold part 156b and the male mold part 158b, is smaller than the volume Vᵢ of the cavities formed upon closure in the first portion 111 of the press 110, between the male mold part 122a and the female mold part 124a, and between the male mold part 122b and the female mold part 124b.

In particular, the cavities of the second portion 112 of the press 110 have a predefined smaller volume V_{f}, calculated in each instance, depending on the requirements of the situation, in proportion to the larger volume Vᵢ of the cavities of the first portion 111 of the press 110.

The difference in volume V_{c} between the volume Vᵢ of the cavities of the first portion 111 and the volume V_{f} of the cavities of the second portion 112 of the press 110 corresponds to the volume of the expanded thermoplastic polymer that will melt and then crystallize following contact with the female mold part 156b and male mold part 158a, which are first superheated and then cooled.

Furthermore, said difference in volume V_{c} corresponds to an offset of a few millimeters of thickness outward in the case of inner shells for helmets with an outer layer of crystallized surface covering, to an offset of a few millimeters of thickness inward in the case of inner shells for helmets with an inner layer of crystallized surface covering, or both in the case of inner shells for helmets with an outer and inner layer of crystallized surface covering.

Therefore, the volume of the layer of crystallized surface covering that is obtained is smaller than the volume V_{c} of the expanded thermoplastic polymer that has melted and then crystallized, and the resulting inner shells for helmets have a final volume V_{f} that is smaller than the initial volume Vᵢ of the expanded thermoplastic polymer that is only sintered in the first portion 111 of the press 110, according to traditional and known techniques and methods.

Operation of the press 110 for molding expanded thermoplastic polymers according to the invention is as follows.

As a preliminary, the male mold part 122b and female mold part 124a are fitted at the chamber 142 of the fixed plane 114 of the first portion 111 of the press 110; the male mold part 122a and female mold part 124b are fitted at the chamber 146 of the movable plane 116 of the first portion 111 of the press 110; the female mold part 156b and male mold part 158a are fitted at the second chamber 176 of the fixed plane 148 of the second portion 112 of the press 110; and the female mold part 156a and male mold part 158b are fitted at the chamber 178 of the movable plane 150 of the second portion 112 of the press 110.

After the fitting of the mold parts for expanded thermoplastic polymers, in the fixed plane 114 of the first portion 111 of the press 110, the following are connected to the corresponding systems: the steam inlet 118, the condensation drain 126, the duct 134 for dispensing cooling water inside the chamber 142.

Likewise, in the movable plane 116 of the first portion 111 of the press 110, the following are connected to the corresponding systems: the steam inlet 120, the condensation drain 128, and the duct 130 for dispensing cooling water inside the chamber 146.

Moreover, in the fixed plane 148 of the second portion 112 of the press 110, the following are connected to the corresponding systems: the steam inlet 152, the condensation drain 160, the duct 166 for dispensing cooling water inside the first chamber 174, the duct 168 for dispensing cooling water on the female mold part 156b and male mold part 158a, the duct 170 for dispensing steam on the female mold part 156b and male mold part 158a, and the corresponding condensation drain duct 172.

Finally, in the movable plane 150 of the second portion 112 of the press 110, the following are connected to the corresponding systems: the steam inlet 154, the condensation drain 162, and the duct 164 for dispensing cooling water inside the chamber 178.

Initially, the fixed plane 114 and the movable plane 116 of the first portion 111 of the press 110 close against each other, with high compression provided by the hydraulic actuators of the movable plane 116; consequently the male mold part 122a closes and compresses with the female mold part 124a, and the male mold part 122b closes and compresses with the female mold part 124b, forming a respective cavity upon closure. In particular, during this step, the expanded thermoplastic polymer being processed is subjected to a compression preferably comprised between 9 bar and 11 bar, even more preferably equal to 10 bar.

At this point, the press 110 is loaded with an expanded thermoplastic polymer in the form of pellets, filling the cavities formed upon closure in the first portion 111 of the press 110, between the male mold part 122a and the female mold part 124a, and between the male mold part 122b and the female mold part 124b.

The freshly loaded expanded thermoplastic polymer sinters by virtue of the steam dispensed in the chamber 142 on the male mold part 122b and female mold part 124a, by means of the steam inlet 118 of the fixed plane 114, and in the chamber 146 on the male mold part 122a and female mold part 124b, by means of the steam inlet 120 of the movable plane 116 of the first portion 111 of the press 110. The steam is dispensed in the chambers 142 and 146 of the first portion 111 of the press 110 at a pressure preferably comprised between 2.5 bar and 3.5 bar, even more preferably equal to 3 bar.

After achieving the correct sintering of the expanded thermoplastic polymer, thus forming inner shells for helmets, cooling water is atomized by means of the corresponding ducts 134 and 130, respectively in the chamber 142 of the fixed plane 114, i.e., on the male mold part 122b and female mold part 124a, and in the chamber 146 of the movable plane 116, i.e., on the male mold part 122a and female mold part 124b.

At the same time, the condensation drains 126 and 128 are opened to allow the exit of condensation respectively from the chamber 142 of the fixed plane 114 and from the chamber 146 of the movable plane 116 of the first portion 111 of the press 110.

The fixed plane 114 and the movable plane 116 of the first portion 111 of the press 110 then open and the partially processed inner shells for helmets obtained so far, which are only sintered, are extracted automatically or manually from the first portion 111 of the press 110.

At this point, the partially processed inner shells obtained so far can be crystallized on their inner or outer surface, depending on the requirements of the situation.

By keeping open the fixed plane 148 and the movable plane 150 of the second portion 112 of the press 110, the partially processed inner shells for helmets obtained so far, which are only sintered, are placed automatically or manually in the second portion 112 of the press 110.

The fixed plane 148 and the movable plane 150 of the second portion 112 of the press 110 then close against each other, with a high compression provided by the hydraulic actuators of the movable plane 150; consequently, the female mold part 156a closes and compresses with the male mold part 158a, and the female mold part 156b closes and compresses with the male mold part 158b, forming a respective cavity upon closure. In particular, during this step, the expanded thermoplastic polymer being processed is subjected to a compression preferably comprised between 9 bar and 11 bar, even more preferably equal to 10 bar.

In the second chamber 176 of the fixed plane 148, i.e., on the female mold part 156b and male mold part 158a, steam is dispensed by means of the duct 170, at a pressure preferably comprised between 5.5 bar and 6.5 bar, even more preferably equal to 6 bar, so that the female mold part 156b and male mold part 158a superheat to a temperature preferably comprised between 150° C. and 170° C., even more preferably equal to 160° C.

The expanded thermoplastic polymer of the partially processed inner shells for helmets thus makes contact with the superheated surfaces of the female mold part 156b and male mold part 158a, and melts superficially for a thickness preferably comprised between 0.8 mm and 1.2 mm, even more preferably equal to 1 mm, while the remaining part or core of the expanded thermoplastic polymer, below the melted surface, sinters by virtue of the steam dispensed on the female mold part 156a and male mold part 158b, at a pressure preferably comprised between 2.5 bar and 3.5 bar, even more preferably equal to 3 bar, by means of the steam inlet 154 of the movable plane 150 of the second portion 112 of the press 110.

The melting of the surface of the expanded thermoplastic polymer in contact with the superheated female mold part 156b and male mold part 158a allows the subsequent crystallization, by cooling, of the outer and inner surface, respectively, of the inner shells for helmets thus obtained, and the consequent forming of a corresponding hard and compact external surface covering layer.

During the crystallization of the outer or inner surface of the inner shells for helmets made of expanded thermoplastic polymer thus obtained, the condensation drain duct 172 remains open to allow the outflow of condensation from the second chamber 176 of the fixed plane 148 of the second portion 112 of the press 110.

After achieving the correct crystallization of the outer or inner surface of the inner shells for helmets, as well as the correct sintering of the non-superficial part or core of the inner shells for helmets, cooling water is atomized by means of the corresponding ducts 166, 168 and 164, respectively in the first chamber 174 of the fixed plane 148, in the second chamber 176 of the fixed plane 148, i.e., onto the female mold part 156b and male mold part 158a, and in the chamber 178 of the movable plane 150, i.e., onto the female mold part 156a and male mold part 158b.

The cooling water dispensed by the duct 168 has priority with respect to other water and becomes active a preset time after the closure of the fixed plane 148 and of the movable plane 150 of the second portion 112 of the press 110, so as to avoid damaging superheatings of the expanded thermoplastic polymer.

At the same time, the condensation drains 160 and 162 are opened to allow the outflow of condensation respectively from the first chamber 174 of the fixed plane 148 and from the chamber 178 of the movable plane 150 of the second portion 112 of the press 110.

Finally, the fixed plane 148 and the movable plane 150 of the second portion 112 of the press 110 open, and inner shells for helmets thus obtained and ready for use, having a crystallized outer or inner surface, are extracted automatically or manually from the second portion 112 of the press 110.

Therefore, the inner shells for helmets thus obtained, once processing has ended, have a core made of sintered expanded thermoplastic polymer, and a hard and compact surface covering layer at their visible surfaces, said surface covering being obtained by crystallization of the expanded thermoplastic polymer.

It should be noted that the thickness of the layer of crystallized surface covering can vary depending on the density and type of expanded thermoplastic polymer used as raw material, depending on the crystallization temperatures and pressures, as well as on the compression force applied.

In a preferred embodiment of the method for molding expanded thermoplastic polymers according to the invention, the volume V_{f} of the cavities formed upon closure between the female mold part 156a and the male mold part 158a, and between the female mold part 156b and the male mold part 158b, during the step for closure and compression of the fixed plane 148 and of the movable plane 150 of the second portion 112 of the press 110, is smaller than the volume Vᵢ of the cavities formed upon closure between the male mold part 122a and the female mold part 124a, and between the male mold part 122b and the female mold part 124b, during the step of closure and compression of the fixed plane 114 and of the movable plane 116 of the first portion 111 of the press 110.

In particular, the cavities of the second portion 112 of the press 110 have a predefined smaller volume V_{f}, calculated in each instance, depending on the requirements of the situation, in proportion to the larger volume Vᵢ of the cavities of the first portion 111 of the press 110.

The difference in volume V_{c} between the volume Vᵢ of the cavities of the first portion 111 and the volume V_{f} of the cavities of the second portion 112 of the press 110 corresponds to the volume of the expanded thermoplastic polymer that will melt and then crystallize following contact with the female mold part 156b and male mold part 158a, which are first superheated and then cooled.

Furthermore, said difference in volume V_{c} corresponds to an offset of a few millimeters of thickness outward in the case of inner shells for helmets with an outer layer of crystallized surface covering, to an offset of a few millimeters of thickness inward in the case of inner shells for helmets with an inner layer of crystallized surface covering, or both in the case of inner shells for helmets with an outer layer and an inner layer of crystallized surface covering.

Therefore, the volume of the layer of crystallized surface covering that is obtained is smaller than the volume V_{c} of the expanded thermoplastic polymer that has melted and then crystallized, and the resulting inner shells for helmets have a final volume V_{f} that is smaller than the initial volume Vᵢ of the expanded thermoplastic polymer merely sintered in the first portion 111 of the press 110, according to traditional known techniques and methods.

In practice it has been found that the invention achieves fully the preset aim and objects. In particular, it has been shown that the press and the method for molding expanded thermoplastic polymers thus conceived allow to overcome the quality limitations of the background art, since they allow to provide manufactured articles made of expanded thermoplastic polymers provided with a hard and compact surface covering layer, to cover totally or partially the surface of said manufactured articles, and optionally with different degrees of surface finish, for example smooth or rough, in any case appearing to users as pleasant to the touch.

Another advantage of the press and of the method for molding expanded thermoplastic polymers according to the present invention resides in that they allow to provide manufactured articles that have a hard and compact surface covering layer, keeping unchanged the specific characteristics of the internal part of said manufactured articles, particularly softness and elasticity.

A further advantage of the press and of the method for molding expanded thermoplastic polymers resides in that they allow to provide manufactured articles that have a hard and compact surface covering layer which makes them durable over time and makes them easier to clean.

Although the press and the method for molding expanded thermoplastic polymers according to the invention have been conceived in particular for the production, by means of an injection molding process, of manufactured articles and components provided by using expanded thermoplastic polymers as raw materials, they can be used in any case, more generally, for the production of manufactured articles and components provided by means of any process for molding expanded thermoplastic polymers.

The invention thus conceived is susceptible of numerous modifications and variations, all of which are within the scope of the appended claims; by way of non-limiting example, the person skilled in the art understands without effort that there can also be a system for the emergency blocking of the press, for example of the mechanical or electronic type. All the details may further be replaced with other technically equivalent elements.

In practice, the materials used, as well as the contingent shapes and dimensions, may be any according to requirements and to the state of the art.

To conclude, the scope of the protection of the claims must not be limited by the illustrations or preferred embodiments shown in the description by way of example, but rather the claims must comprise all the characteristics of patentable novelty that reside in the present invention, including all the characteristics that would be treated as equivalents by the person skilled in the art.

The disclosures in Italian Patent Application No. 102016000025592 (UA2016A001558) from which this application claims priority are incorporated herein by reference.

1-21. (canceled)

22. A press for molding expanded thermoplastic polymers, comprising at least one portion comprising a fixed plane with a first chamber and a movable plane with a chamber, said fixed plane and said movable plane comprising at least one male mold part and at least one female mold part, which form at least one cavity upon closure, wherein said fixed plane of said at least one portion comprises, in a second chamber obtained inside said first chamber, a duct for dispensing steam inside said second chamber, adapted to superheat said at least one male mold part and/or said at least one female mold part, and a duct for dispensing water inside said second chamber, adapted to cool said at least one male mold part and/or said at least one female mold part, and a condensation discharge duct.

23. The press for molding expanded thermoplastic polymers according to claim 22, further comprising a first portion and a second portion, said fixed plane of said first portion comprising at least one male mold part and said movable plane of said first portion comprising at least one female mold part, said fixed plane of said second portion comprising at least one female mold part and said movable plane of said second portion comprising at least one male mold part.

24. The press for molding expanded thermoplastic polymers according to claim 22, further comprising a first portion and a second portion, said fixed plane comprising at least one male mold part and at least one female mold part and said movable plane comprising at least one male mold part and at least one female mold part.

25. The press for molding expanded thermoplastic polymers according to claim 23, wherein the volume of said at least one cavity formed upon closure in said second portion, between said at least one female mold part and said at least one male mold part, is smaller than the volume of said at least one cavity formed upon closure in said first portion, between said at least one male mold part and said at least one female mold part.

26. The press for molding expanded thermoplastic polymers according to claim 22, further comprising an injector of an expanded thermoplastic polymer in the shape of pellets, which is connected to said at least one female mold part.

27. The press for molding expanded thermoplastic polymers according to claim 22, wherein said fixed plane of said at least one portion further comprises, in said first chamber, a steam inlet, a condensation drain, and a duct for dispensing cooling water.

28. The press for molding expanded thermoplastic polymers according to claim 27, wherein said movable plane of said at least one portion further comprises, in said chamber, a steam inlet, a condensation drain, and a duct for dispensing cooling water.

29. The press for molding expanded thermoplastic polymers according to claim 28, wherein one or more of said ducts for dispensing cooling water comprises atomizing nozzles.

30. A method for molding expanded thermoplastic polymers, comprising the steps of:
closing and compressing against each other at least one male mold part and at least one female mold part, forming at least one cavity upon closure;
dispensing steam, superheating said at least one male mold part and/or said at least one female mold part;
dispensing cooling water, cooling said at least one male mold part and/or said at least one female mold part;
opening said at least one male mold part and said at least one female mold part;
extracting at least one obtained manufactured article.

31. The method for molding expanded thermoplastic polymers according to claim 30, further comprising the steps of:
closing and compressing against each other a fixed plane and a movable plane of a press;
dispensing steam, within at least one second chamber of said fixed plane, superheating said at least one male mold part and/or said at least one female mold part, comprised in said fixed plane;
dispensing steam within at least one chamber of said movable plane, superheating said at least one female mold part and/or said at least one male mold part comprised in said movable plane;
dispensing cooling water within said at least one second chamber of said fixed plane, cooling said at least one male mold part and/or said at least one female mold part comprised in said fixed plane;
dispensing cooling water within said at least one chamber of said movable plane, cooling said at least one female mold part and/or said at least one male mold part comprised in said movable plane;
opening said fixed plane and said movable plane of said press;
extracting from said press said at least one obtained manufactured article.

32. The method for molding expanded thermoplastic polymers according to claim 31, wherein the volume of said at least one cavity formed between said at least one female mold part and said at least one male mold part during said closing and compression step of said fixed plane and of said movable plane of a second portion of said press is smaller than the volume of said at least one cavity formed between said at least one male mold part and said at least one female mold part during said closing and compression step of said fixed plane and said movable plane of a first portion of said press.

33. The method for molding expanded thermoplastic polymers according to claim 30, further comprising the step of loading said at least one female mold part with an expanded thermoplastic polymer in the form of pellets.

34. The method for molding expanded thermoplastic polymers according to claim 33, wherein said step of loading said at least one female mold part comprises the step of injecting at high pressure said expanded thermoplastic polymer in the form of pellets within said at least one female mold part.

35. The method for molding expanded thermoplastic polymers according to claim 30, wherein said step of closing and compressing one against the other said at least one male mold part and said at least one female mold part provides for a compression comprised between 9 bar and 11 bar.

36. The method for molding expanded thermoplastic polymers according to claim 30, wherein said step of dispensing steam, superheating said at least one male mold part and/or said at least one female mold part, provides for a pressure of the steam comprised between 5.5 bar and 6.5 bar and a superheating temperature of said at least one male mold part and/or of said at least one female mold part comprised between 150° C. and 170° C.

37. The method for molding expanded thermoplastic polymers according to claim 30, further comprising a step of positioning said at least one manufactured article on said at least one male mold part of said press.

38. The method for molding expanded thermoplastic polymers according to claim 31, wherein said step of dispensing steam within said at least one second chamber of said movable plane, superheating said at least one female mold part and/or said at least one male mold part, provides for a pressure of the steam comprised between 2.5 bar and 3.5 bar.

39. The method for molding expanded thermoplastic polymers according to claim 31, further comprising a step of opening a condensation drain duct of said fixed plane of said press.

40. The method for molding expanded thermoplastic polymers according to claim 31, further comprising a step of opening a condensation drain of said fixed plane or of said movable plane of said press.

41. The method for molding expanded thermoplastic polymers according to claim 30, wherein said at least one manufactured article is an inner shell for a protective helmet.

42. An inner shell for protective helmet obtainable by means of the method for molding expanded thermoplastic polymers according to claim 41.
